(19) United States
(12) Patent Application Publication
(10) Pub. No.: US 2002/0147882 A1
(43) Pub. Date: Oct. 10, 2002

(54) Universal serial bus flash memory storage device

(76) Inventors: Khein Seng Pua, Chutung (TW); Chee Kong Awyong, Chutung (TW)

Correspondence Address: Khein Seng PUA, 114 Collims Street, San Francisco, CA, 94118, US

(21) Appl. No.: 09/828,992

(22) Filed: Apr. 10, 2001

(51) Int. Cl. G06F 13/00

(52) U.S. Cl. 711/103; 711/154

(57) ABSTRACT

The invention provides a flash memory storage device that is connectable to a computer via a universal serial bus. The universal serial bus (USB) has become a standard serial interface which allows data to be stored in and read from an external memory device at high speed. Therefore, it is advantageous to combine the benefits of a flash memory device with the speed of the universal serial bus. In addition, by designing the flash memory device with a USB interface, the flash memory device appears as a standard USB storage device which permits the host and flash memory device to connect and interact with ease.

### BACKGROUND OF THE INVENTION

1. Field of Invention

The present invention relates to a flash memory device, and more particularly, to a flash memory storage device that is connectable via a universal serial bus.

2. Description of Related Art

Flash memory has become an important means of storing data which offers portability. This is an extremely useful way of storing data for portable devices such as handheld devices. The convenience that flash memory provides gives it numerous advantages over traditional mass storage devices such as hard disks. Besides portability, flash memory further offers advantages such as low power consumption, reliability, small size and high speed.

Flash memory is non-volatile which means that it retains its stored data even after power is turned off This is an improvement over standard random access memory (RAM) which is volatile and therefore looses stored data when power is turned off.

As the number of mobile, portable, or handheld devices grows, the popularity of flash memory increases. The most common type of flash memory is in the form of a removable memory card. This card allows the contents of the flash memory to be transferred easily between devices or computers.

However, when moving the flash memory card between devices, an additional host or adapter is required in order for the host to communicate with the flash card. Many devices may not have the built-in ability to connect to a flash card, therefore a special adapter or card must be installed in the host device. In addition, the bus architecture can limit the speed of data transfer between the host and flash memory device.

Therefore, there is a need for a flash memory device that can be directly connected to a host device without the need for special cables or adapters.

### SUMMARY OF THE INVENTION

To achieve these and other advantages and in order to overcome the disadvantages of a conventional flash memory card in accordance with the purpose of the invention as embodied and broadly described herein, the present invention provides a flash memory storage device that is connectable to a host via a universal serial bus.

The universal serial bus (USB) has become a standard serial interface which allows data to be stored in and read from an external memory device at high speed. Therefore, it is advantageous to combine the benefits of a flash memory device with the speed of the universal serial bus. In addition, by designing the flash memory device with a USB interface, the flash memory device appears as a standard USB storage device which permits the host and flash memory device to connect and interact with ease.

The main board of the flash memory storage device comprises a controller and at least one flash memory chip. A USB connector connects the flash memory storage device with a USB host. The flash memory on the main board comprises at least one flash memory chip but as described below, the memory capacity of the flash memory device can be easily expanded.

In an embodiment of the present invention, the memory storage device further comprises an extension stack connector that allows for extending the number of flash memories on slave boards. The extension stack connector connects the pins needed by the flash memory chip on the slave board with the controller on the main board. In this way, the memory capacity of the flash memory device can be conveniently expanded as required.

The controller is a major component of the device. The controller controls commands and data between the USB host and manages data in the flash memory array or module. It is preferred that the controller is of a single chip design that does not need external ROM or RAM.

A regulator regulates the voltage for the memory storage device. Typically, flash memory requires 3.3 volts or 5.0 volts. Some flash memory devices utilize means of switching between 3.3 volts and 5.0 volts as required by the flash memory. However, an advantage of the flash memory device of the present invention is that the flash memory device only needs 3.3 volts. Therefore, regardless if 5.0 volts or 3.3 volts is received from the host, the regulator will ensure that 3.3 volts is available for the USB transceiver without the need for detecting and converting the voltage.

A clock generator, for example a crystal, generates a clock signal for the controller of the flash memory device.

The flash memory storage device of an embodiment of the present invention further comprises an indicator, for example an LED indicator, which indicates the status of the memory storage device such as whether it is busy or in standby.

The main board of the flash memory device can also have a stack connector for connecting a slave board to the main board for extending the memory size with flash memory arrays. The slave board comprises at least one additional flash memory module or array. Multiple slave boards can be connected in order to provide unlimited memory expansion.

A write protection switch provides write protection from the USB host. The switch has at least two positions; a position for allowing the host to read and write normally, and another position for write protection. When the switch is in the write protect position, the host can read data but cannot write or erase data.

The controller of the flash memory device of the present invention performs numerous functions. Among these functions is controlling the USB interface. The controller follows the USB specification for physical and logical protocol. The controller further comprises a FIFO controller buffer. The controller receives command and parameter packets from the USB host, which are then stored in a special register defined by the controller. The controller is also responsible for controlling the transfer of data to and from the USB host. In addition, the controller also provides status data to the USB host.

When the host sends a write command, an interrupt is generated and sent to the controller microprocessor to inform the microprocessor of the command and the command location. The microprocessor, for example an 8 or 16-bit microprocessor, is a major component of the controller. The microprocessor reads the USB commands and parameters from the register. The microprocessor also executes the commands with parameters. The microprocessor manages and maps the USB FIFO address to the controller buffer while receiving or transferring data to and from the USB host Also, the microprocessor manages commands such as erase, program, or read for the flash memory array. In addition, the microprocessor executes the addressing method according to the algorithm of the controller.

Microprocessor ROM stores the program code of the controller and is built into the controller. Microprocessor RAM is a system RAM used by the controller when executing USB commands or the flash algorithm. By eliminating the requirement for off-chip memory, the system cost is reduced.

A system buffer is used as a cache, which is provided for buffering between the USB interface and the flash memory array interface. It is also the FIFO of the USB protocol and the direction map to the buffer. The microprocessor manages the addresses of this buffer. As required, the buffer can be accessed by byte or word.

The flash memory storage device of the present invention further comprises a hardware state machine for creating the read and write timing to the system buffer between the USB host and the flash memory. A flash interface and circuit, controls the read and write commands to the flash memory array. In an embodiment of the present invention this is a pure hardware circuit.

In addition, an ECC circuit encodes the ECC code while data is writing to the flash memory array from the buffer cache and decodes the ECC code while data is read from the flash memory array to the buffer cache. If an ECC error occurs, the ECC circuit will determine the word or byte address in the buffer cache and correct the error.

The USB command implementation comprises the controller receiving commands and parameters from the USB host and storing them in a register defined by the controller. An interrupt is generated and sent to inform the microprocessor that a command has been received.

The controller receives and transfers data to and from the USB host according to the USB logical and physical specification. The addressing method comprises managing the flash memory erase, read, and write commands and manages the physical to logical mapping.

When the USB Host writes a command and parameter to the memory storage device, the controller will store it in a specified register. The data will then be read by the microprocessor as information from the USB host. According to the standard USB specification, the request parameter comprises 7 bits as shown in FIG. 5. Bits D6-D5 of the bmRequestType designate the type of command protocol. The types include standard, class, and vendor The flash memory device of the present invention supports all three of these types of protocols. The standard type is the standard device request, which is a common command such as USB_Get_Status or USB_set_Feature.

An embodiment of the flash memory storage device of the present invention utilizes the USB mass storage class with the bulk/control/interrupt transport.

Due to the physical limit of the flash memory, before the write command can be performed, an erase command must be executed first. Typical flash memory can function normally only until being erased about one million times, so minimizing the erase steps to maximize the flash memory's usage life is very important. Therefore, the present invention provides a link table and a mother/child framework to achieve this aim.

Following is a description of the use of the link table. When initializing flash, all blocks are searched and a record of the relationship between the physical and logical block that the search has found, becomes the link table. At the same time, the unused physical blocks are put into the spare region for the FIFO queue to use. Next, the logical block in the Link Table is used to find the corresponding physical block address. By doing so, data associated with a particular physical block can accurately be written or retrieved.

When writing data to the flash memory, an erased block (new block) may need to be taken to replace an old block. Then data is written into the new block. Finally, the data which has not changed is moved from the old block to the new block. This completes the action of writing a page's data.

If multiple pages of data are to be written, the above steps are repeated. However, if data is repeatedly written into the same block, many unnecessary erase and move actions are performed. This not only wastes time but also reduces the lifetime of the flash. Therefore, in the flash memory device of the present invention, the erase action is avoided when repeatedly writing data to the same block and the move action is performed only when changing blocks. By using this method, not only is the lifetime of the flash increased but the efficiency of the device is also increased.

Following is a write data example. 32 sectors of data are to be written to flash which starts at block/page 0/0. The total physical block/logical block is 1024/992. The total spare blocks for the FIFO is 32. No blocks are defective. There are 32 pages per block. Child block number 03E0h, which is pointed to by the head pointer is taken from the FIFO spare region. The head pointer is then incremented and 32 pages of data are programmed into the child block. Child block number 03E0h is filled into the mother block's logical block address 0000h in the link table Mother block 0000h is erased and the tail pointer is incremented. Then, mother block number 0000h is filled into the tail pointer point address in the spare region.

Following is a description of a write procedure according to an embodiment of the present invention.

The host writes the corresponding write command and the address parameter to the memory storage device which then begins execution of the program flash algorithm. Then, the logical address from the USB host is converted to the flash memory physical block and page address. The controller checks to see if a child block exists.

If a child block doesn't exist, a clean block is taken from the FIFO queue to create a child block for the current write command. Then, the current flash memory logical page number is checked to see if what is to be written is equal to “0” or not. If equal to “0”, the data from the host to the flash memory is programmed into the buffer and the sector count number is decremented. This process is repeated until the sector count number is equal to “0”. If what is to be written is not equal to “0”, the data from the mother block (which is clean) is moved to the child block between the sections “last page written” and the “current write page”. Then, the data from the host to the flash memory is programmed into the buffer and the sector count number is decremented. This process is repeated until the sector count number is equal to “0”.

If a child block exists, the current flash memory's logical block is checked to see if what is to be written is equal to the last flash memory logical block that was written. If it is not equal, the data from the mother block is moved to the child block between the sections “last page written” and the “end page of this block”. Then, the mother block is erased. The link table in the controller is updated substituting the original mother block address with the child block address. Then, the erased mother block is put back into the FIFO queue as a clean block. If what is to be written is equal to the last flash memory logical block that was written, the current flash memory logical page number is checked to see if what is to be written is larger than the last flash memory logical page that was written. If it is larger, the current write page number is checked to see if it is equal to the last page written plus 1. If yes, the data from the host to the flash memory is programmed into the buffer and the sector count number is decremented. This programming process is repeated until the sector count number is equal to “0”. If the current write page number is not equal to the last page written plus 1, the data from the mother block (which is clean) is moved to the child block between the sections “last page written” and the “current write page”.

If what is to be written is not larger than the last flash memory logical page that was written, the data from the mother block is moved to the child block between the sections “last page written” and the “end page of this block”. Then, the mother block is erased. The link table in the controller is updated substituting the original mother block address with the child block address. Then, the erased mother block is put back into the FIFO queue as a clean block.

If what is to be written is larger than the last flash memory logical page that was written, the data from the mother block is moved to the child block between the “last page written” and the “current write page” sections. The data from the host to the flash memory is programmed into the buffer and the sector count number is decremented. The data is programmed until the sector count number equals zero.

For a read procedure of the flash memory device according to an embodiment of the present invention, the logical address from the USB host is converted to the flash memory physical block and page address. Then, the current flash memory logical block is checked to see if what is to be read is equal to the last flash memory logical block that was read. If no, the data from the flash memory physical block and page is read and the sector count number is decremented. This process is repeated until the sector count number equals “0”. If what is to be read is equal to the last flash memory logical block that was read, the current flash memory logical page is checked to see if what is to be read is larger than the last flash memory logical page that was written.

If yes, the data from the flash memory physical block and page is read and the sector count number is decremented. This process is repeated until the sector count number equals “0”. If what is to be read is not larger than the last flash memory page that was written, the data from the child block physical block and page is read and the sector count number is decremented. This process is repeated until the sector count equals “0”.

When the microprocessor begins to execute the command, the device will download its parameters from the host, for example, read or write, the vendor command packet. The system will judge the address mode by bit 6 of the Device/Head byte. The flash memory device of the present invention supports both the logical block address (LBA) and the cylinder head sector (CHS) mode. If the host provides the address using LBA mode, the device will convert it into CHS mode and then change the CHS mode into the physical address.

When the device executes a read command, the controller will first read data from the flash memory, sector by sector to a buffer (512 bytes) in the controller, then this sector will be sent to the host by a USB engine. The whole command will be completed when the number of sectors that have been sent to the host is equal to the sector count.

When the device executes a write command, the controller will read data from the host by the USB engine sector by sector to a buffer (512 bytes) in the controller, and then this sector will be stored in the flash memory. The whole command will be completed when the number of sectors that have been sent to the flash memory is equal to the sector count.

The device can support more than one piece of flash memory. In the present invention, multiple chip select pins are provided. When the device is initialized, it will check the type of the flash (the capacity) being used on board and how many chips the system has and the device will add up all the memory chips to find out the total capacity. When the host needs this kind of data, the device will provide the total capacity to the host, not just the capacity of one chip.

When the host sends a certain address (logic) to the device, the device will perform a calculation to find the exact chip and corresponding address that the host wants to access. Then the device will use the calculated address and enable the chip select pin.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1a is a diagram showing a layout of the flash memory device according to an embodiment of the present invention;

FIG. 1b is a diagram showing a layout of a flash memory slave board according to an embodiment of the present invention,

FIG. 2 is a block diagram of a flash memory storage device controller according to an embodiment of the present invention;

FIG. 3 is a block diagram of the system architecture of a flash memory storage device according to an embodiment of the present invention;

FIG. 4 is a flowchart of the application of the USB protocol for various operating systems according to an embodiment of the present invention;

FIG. 5 is a table listing parameters of the USB protocol implemented in the flash memory device according to an embodiment of the present invention;

FIG. 6 is a flowchart showing the write procedure of the flash memory device according to an embodiment of the present invention;

FIG. 7 is a flowchart showing the read procedure of the flash memory device according to an embodiment of the present invention;

FIG. 8 is a block diagram showing writing data to a new block according to an embodiment of the present invention;

FIG. 9 is a block diagram showing writing additional pages of data according to an embodiment of the present invention;

FIG. 10 is a block diagram showing the mother and child technique according to an embodiment of the present invention;

FIG. 11 is a diagram showing the link table according to an embodiment of the present invention;

FIG. 12 is a diagram showing the head pointer and tail pointer operation of an embodiment of the present invention;

FIG. 13 is a diagram showing the link table before programming according to an embodiment of the present invention;

FIG. 14 is a diagram showing the head pointer and tail pointer operation of an embodiment of the present invention; and

FIG. 15 is a diagram showing a command packet structure according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

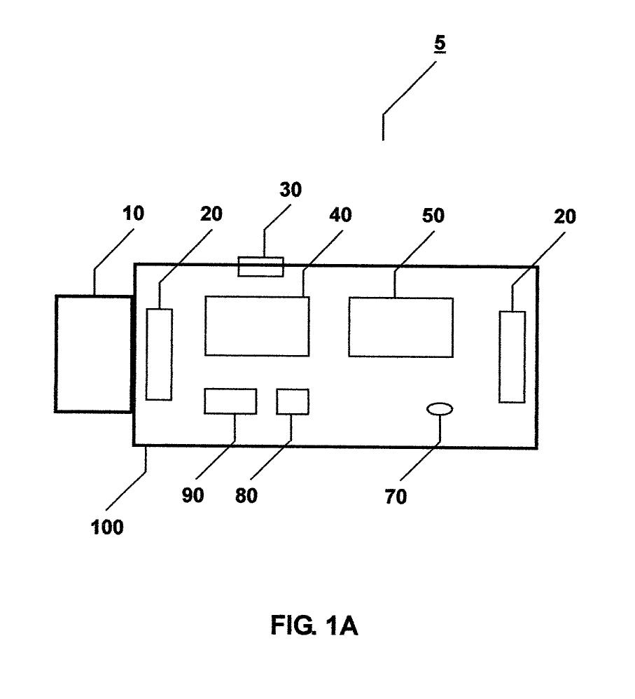

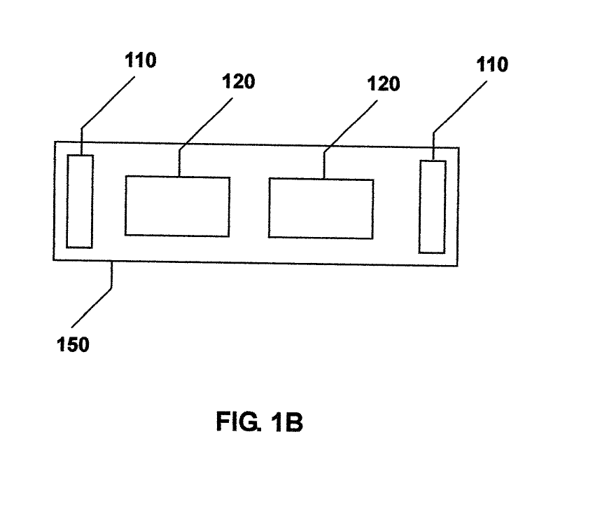

Refer to FIG. 1a, which is a PCB layout block diagram of a flash memory storage device utilizing a USB interface according to an embodiment of the present invention and FIG. 1b, which is a PCB layout block diagram of a flash memory slave device according to an embodiment of the present invention.

The main board 100 of the flash memory storage device 5 comprises a controller 40 and at least one flash memory chip 50. A USB connector 10 connects the flash memory storage device 5 with a USB host (not shown). The flash memory on the main board 100 comprises at least one flash memory chip 50 but as described below, the memory capacity of the flash memory device 5 can be easily expanded.

In an embodiment of the present invention, the flash memory storage device 5 further comprises an extension stack connector 20 that allows for extending the number of flash memories 120 on slave boards 150. The extension stack connector 20 connects the pins needed by the flash memory 120 on the slave board with the controller 40 on the main board 100. In this way, the memory capacity of the flash memory device 5 can be conveniently expanded as required.

The controller 40 is a major component of the device. The controller 40 controls commands and data between the USB host and manages data in the flash memory array or module. It is preferred that the controller 40 is of a single chip design that does not need external ROM or RAM.

A regulator 90 regulates the voltage for the memory storage device 5. Typically, flash memory requires 3.3 volts or 5.0 volts. Some flash memory devices utilize means of switching between 3.3 volts and 5.0 volts as required by the flash memory. However, an advantage of the flash memory device 5 of the present invention is that the flash memory device 5 only needs 3.3 volts. Therefore, regardless if 5.0 volts or 3.3 volts is received from the host, the regulator 90 will ensure that 3.3 volts is available for the device 5 without the need for detecting and converting the voltage.

A clock generator 80, for example a crystal, generates a clock signal for the controller 40 of the flash memory device 5.

The flash memory storage device 5 of an embodiment of the present invention further comprises an indicator 70, for example an LED indicator, which indicates the status of the flash memory storage device 5 such as whether it is busy or in standby.

The main board 100 of the flash memory device 5 can also have a stack connector 20 for connecting a slave board 150 to the main board 100 for extending the memory size with additional flash memory 120. The slave board 150 comprises at least one additional flash memory array or module 120. Multiple slave boards can be connected in order to provide unlimited memory expansion.

A write protection switch 30 provides write protection from the USB host. The switch 30 has at least two positions; a position for allowing the host to read and write normally, and another position for write protection. When the switch 30 is in the write protect position, the host can read data but cannot write or erase data.

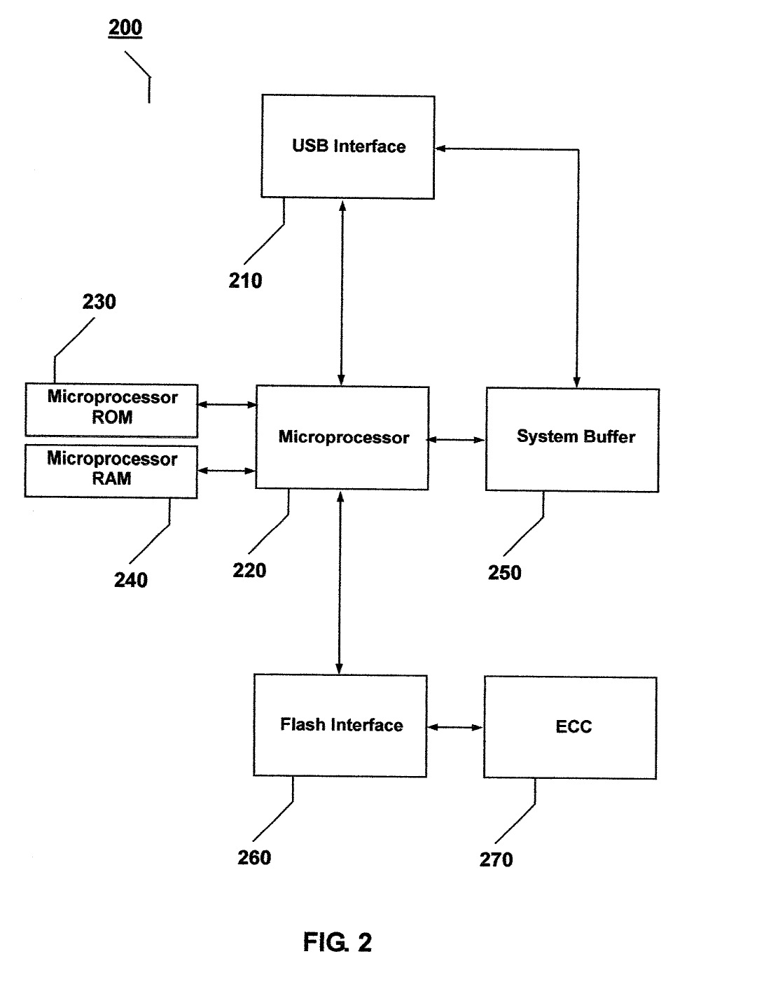

Refer to the FIG. 2, which is a block diagram of a flash memory storage device controller according to an embodiment of the present invention.

The controller 200 of the flash memory device of the present invention performs numerous functions. Among these functions is controlling the USB interface 210.

The controller 200 follows the USB specification for physical and logical protocol. The controller 200 further comprises a system buffer 250 or FIFO controller buffer.

The controller 200 receives command and parameter packets from the USB host, which are then stored in the system buffer 250 defined by the controller 200. The controller 200 is also responsible for controlling the transfer of data to and from the USB host.

In addition, the controller 200 also provides status data to the USB host.

When the host sends a write command, an interrupt is generated and sent to the controller microprocessor 220 to inform the microprocessor 220 of the command and the command location.

The microprocessor 220, for example an 8 or 16-bit microprocessor, is a major component of the controller 200. The microprocessor 220 reads the USB commands and parameters from the system buffer 250. The microprocessor 220 also executes the commands with parameters.

The microprocessor 220 manages and maps the USB FIFO address to the controller system buffer 250 while receiving or transferring data to and from the USB host.

Also, the microprocessor 220 manages commands such as erase, program, or read for the flash memory array. In addition, the microprocessor 220 executes the addressing method according to the algorithm of the controller 200.

Microprocessor ROM 230 stores the program code of the controller 200 and is built into the controller 200. Microprocessor RAM 240 is a system RAM used by the controller 200 when executing USB commands or the flash algorithm. By eliminating the requirement for off-chip memory, the system cost is reduced.

A system buffer 250 is used as a cache which is provided for buffering between the USB interface 210 and the flash memory array interface 260. It is also the FIFO of the USB protocol and the direction map to the buffer. The microprocessor 220 manages the addresses of this buffer. As required, the buffer can be accessed by byte or word.

The flash memory storage device of the present invention further comprises a hardware state machine for creating the read and write timing to the system buffer 250 between the USB host and the flash memory.

The flash interface 260 and circuit, controls the read and write commands to the flash memory array. In an embodiment of the present invention this is a pure hardware circuit.

An ECC circuit 270 encodes the ECC code while data is writing to the flash memory array from the buffer cache and decodes the ECC code while data is read from the flash memory array to the buffer cache. If an ECC error occurs, the ECC circuit 270 will determine the word or byte address in the buffer cache and correct the error.

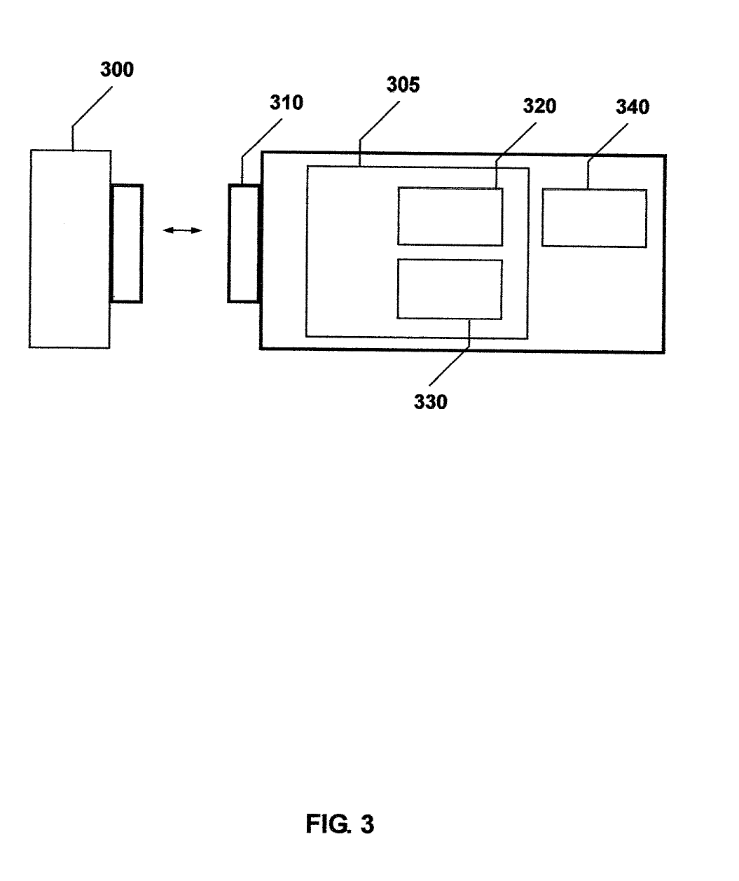

Refer to FIG. 3, which is a block diagram of the system architecture of a flash memory storage device according to an embodiment of the present invention.

Certain operating systems of the USB host 300 such as Windows ME and Windows 2000 contain default USB device drivers. Other operating systems may require the need for a USB device driver to be installed on the host.

The USB command implementation 320 comprises the controller 305 receiving commands and parameters from the USB host 300 via the USB connector 310 and storing them in a register defined by the controller. An interrupt is generated and sent to inform the microprocessor that a command has been received.

The controller 305 receives and transfers data to and from the USB host 300 according to the USB logical and physical specification.

The addressing method 330 comprises managing the flash memory 340 erase, read, and write commands and manages the physical to logical mapping.

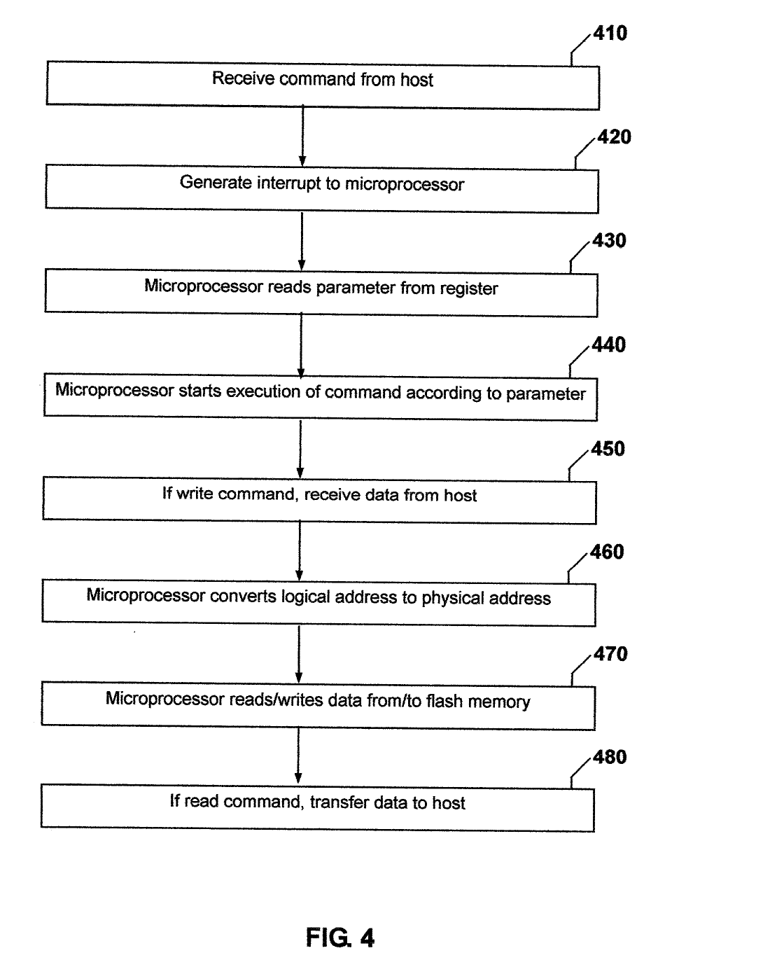

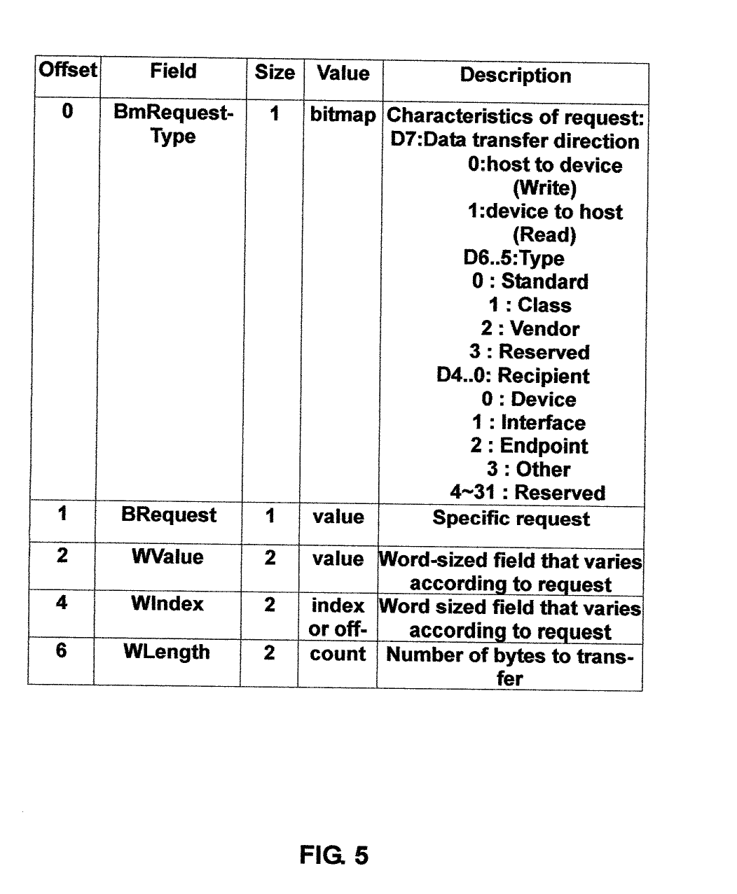

Refer to FIG. 4, which is a flowchart of the application of the USB protocol for various operating systems. Also refer to FIG. 5, which is a table listing parameters of the standard USB protocol.

When the USB Host writes a command and parameter to the memory storage device in step 410, the controller will store it in a specified register and generates an interrupt to the microprocessor in step 420. The data will then be read by the microprocessor as information from the USB host in step 430.

In step 440, the microprocessor begins execution of the command according to the parameter. If the command is a write command, the data from the USB host to the buffer cache is received in step 450.

The microprocessor then converts the logical address to the flash memory physical address in step 460 The microprocessor then reads/writes data to/from flash memory in step 470.

In step 480, the data is transferred to the USB host if the command is a read command.

According to the standard USB specification, the request parameter comprises 7 bits as shown in FIG. 5.

Bits D-6-D5 of the bmRequestType designate the type of command protocol. The types include standard, class, and vendor. The flash memory device of the present invention supports all three of these types of protocols.

The standard type is the standard device request, which is a common command such as USB_Get_Status or USB_set_Feature.

An embodiment of the flash memory storage device of the present invention utilizes the USB mass storage class with the bulk/control/interrupt transport.

Due to the physical limit of the Flash Ram, before the write command can be done, an erase command must be executed first. Typical flash memory can function normally only until being erased about one million times, so minimizing the erase steps to maximize the flash memory's usage life is very important. Therefore, the present invention provides a link table and a mother/child framework to achieve this aim.

Following is a description of the use of the link table. When initializing flash, all blocks are searched and a record of the relationship between the physical and logical block that the search has found, becomes the link table. At the same time, the unused physical blocks are put into the spare region for the FIFO queue to use.

Next, the logical block in the Link Table is used to find the corresponding physical block address. By doing so, data associated with a particular physical block can accurately be written or retrieved.

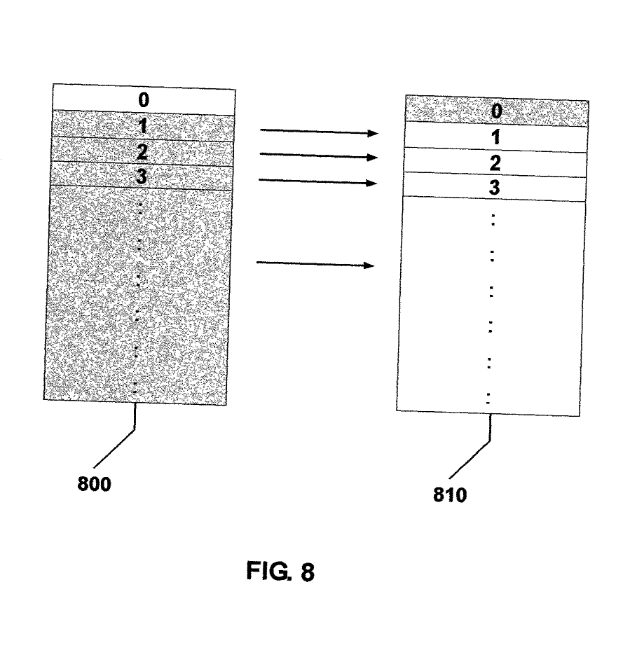

Refer to FIG. 8, which is a block diagram showing writing data to a new block according to an embodiment of the present invention. When writing data to the flash memory, an erased block (new block) 810 may need to be taken to replace an old block 800. Then data is written into the new block 810. Finally, the data which has not changed is moved from the old block 800 to the new block 810. This completes the action of writing a page's data.

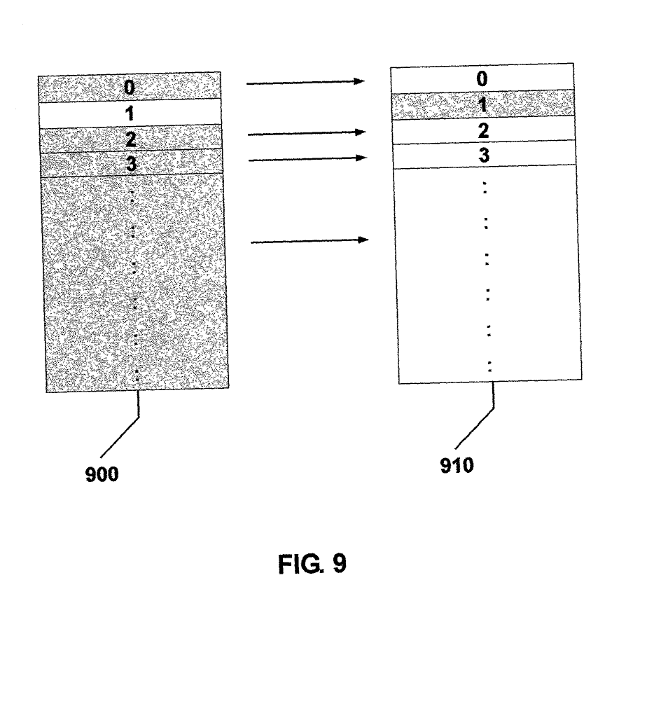

If multiple pages of data are to be written, the above steps are repeated. Refer to FIG. 9, which is a block diagram showing writing additional pages of data according to an embodiment of the present invention. Data is written into the new block 910 and the data which has not changed is moved from the old block 900 to the new block 910.

However, if data is repeatedly written into the same block, many unnecessary erase and move actions are performed. This not only wastes time but also reduces the lifetime of the flash.

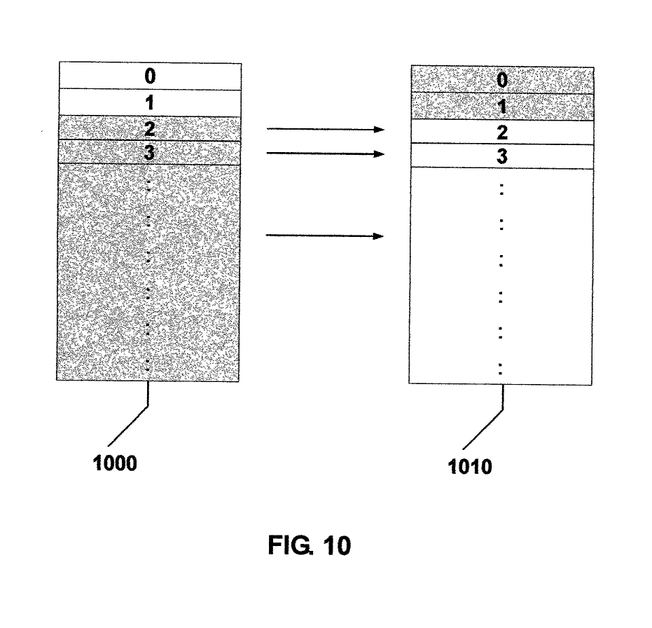

Refer to FIG. 10, which is a block diagram showing the mother and child technique according to an embodiment of the present invention. Therefore, in the flash memory device of the present invention, the erase action is avoided when repeatedly writing data to the same block and the move action is performed only when changing blocks. All data is written into the new block 1010 first. In this example both page 0 and page 1 are written into the new block 1010. Then, the data that hasn't changed is moved from the old block 1000 into the new block 1010. By using this method, not only is the lifetime of the flash increased but the efficiency of the device is also increased.

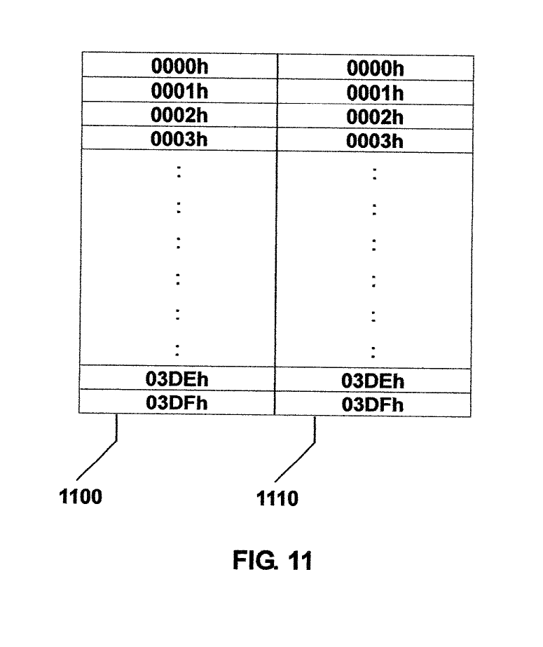

Refer to FIG. 11, which is a diagram showing the link table according to an embodiment of the present invention.

Following is a write data example. The link table links a physical block address 1100 and a logical block address 1110. 32 sectors of data are to be written to flash which starts at block/page 0/0. The total physical block/logical block is 1024/992. The total spare blocks for the FIFO is 32. No blocks are defective. There are 32 pages per block.

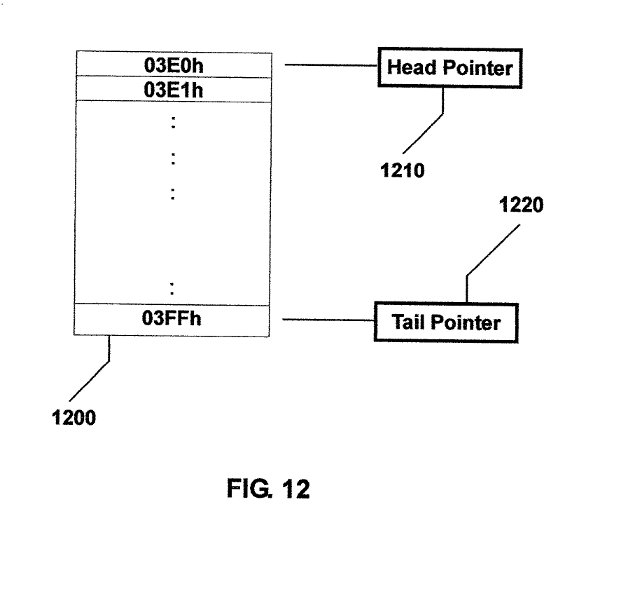

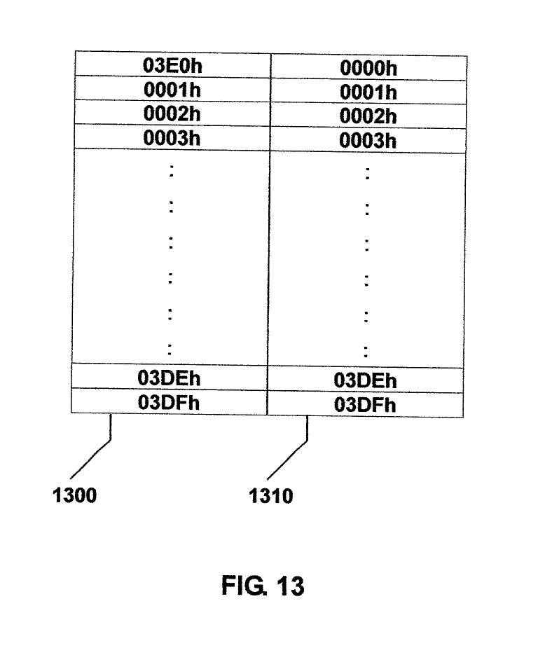

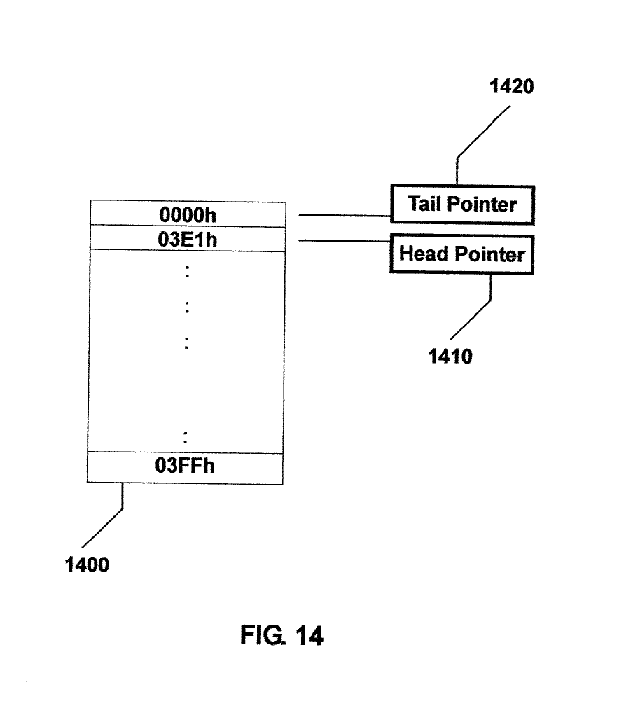

Refer to FIG. 12, which is a diagram showing the head pointer and tail pointer operation of an embodiment of the present invention, FIG. 13, which is a diagram showing the link table before programming according to an embodiment of the present invention, and FIG. 14, which shows the head pointer and tail pointer operation of an embodiment of the present invention.

For this example, child block number 03E0h, which is pointed to by the head pointer 1210 is taken from the FIFO spare region 1200. The head pointer 1410 is then incremented and 32 pages of data are programmed into the child block.

Child block number 03E0h is filled into the mother block's logical block address 0000h in the link table. Mother block 0000h is erased and the tail pointer 1220 is incremented, Then, mother block number 0000h is filled into the tail pointer 1420 point address in the spare region.

Reference will now be made to a description of a write procedure according to an embodiment of the present invention.

The USB Host writes the corresponding write command and the address parameter to the memory storage device which then begins execution of the program flash algorithm.

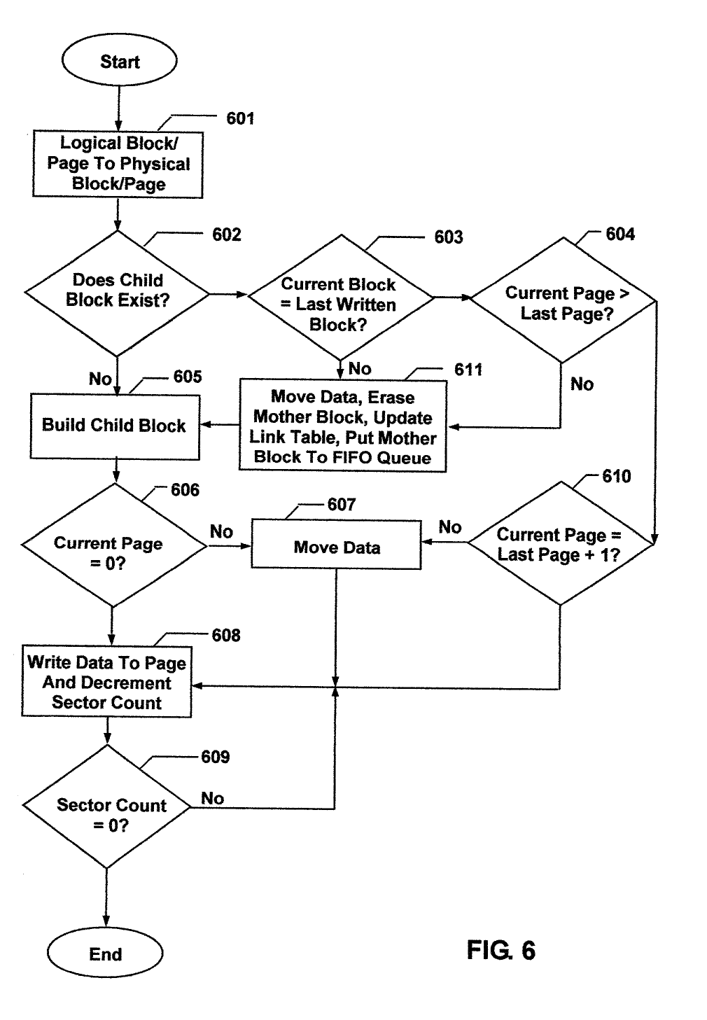

Refer to FIG. 6, which is a flowchart showing the write procedure of the flash memory device according to an embodiment of the present invention.

First in step 601, the logical address from the USB host is converted to the flash memory physical block and page address.

Then in step 602, the controller checks to see if a child block exists. If the child block doesn't exist, proceed to step 605. If the child block exists, in step 603, the current flash memory's logical block is checked to see if what is to be written is equal to the last flash memory logical block that was written. If it is not equal, proceed to step 611.

If it is equal, in step 604 the current flash memory logical page number is checked to see if what is to be written is larger than the last flash memory logical page that was written. If yes, proceed to step 610, otherwise go to step 611.

In step 605, a clean block is taken from the FIFO queue to create a child block for the current write command.

In step 606, the current flash memory logical page number is checked to see if what is to be written is equal to “0” or not. If equal to “0”, proceed to step 608.

If not equal to “0”, in step 607, the data from the mother block is moved to the child block between the “last page written” and the “current write page” sections.

In step 608, the data from the host to the flash memory is programmed into the buffer and the sector count number is decremented.

In step 609, if the sector count number is equal to “0”, go to “End”, otherwise go to step 608.

In step 610, if the current write page number is equal to the last write page number plus 1, go to step 608, otherwise go to step 607.

In step 611, the data from the mother block is moved to the child block between the sections “last page written” and the “end page of this block”.

In step 612, the mother block is erased.

In step 613, the link table in the controller is updated substituting the original mother block address with the child block address.

In step 614, the erased mother block is put back into the FIFO queue as a clean block.

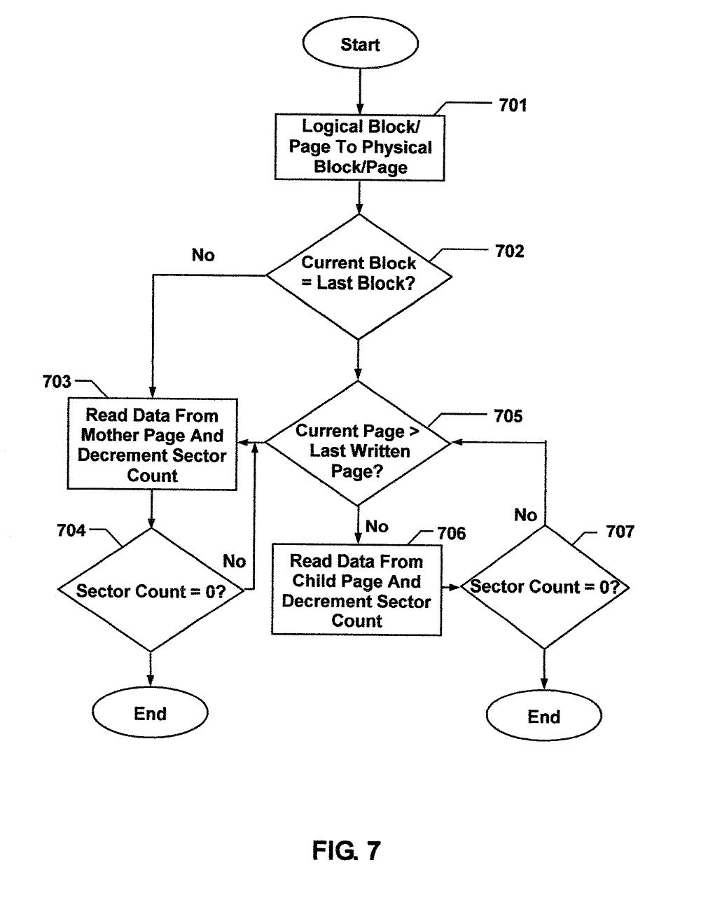

Refer to FIG. 7, which is a flowchart showing the read procedure of the flash memory device according to an embodiment of the present invention.

In step 701, the Logical Address from the USB host is converted to the flash memory physical block and page address.

In step 702, the current flash memory logical block is checked to see if what is to be read is equal to the last flash memory logical block that was read. If yes, go to the step 705, otherwise go to step 703.

In step 703, the data from the flash memory physical block and page is read and the sector count number is decremented.

In step 704, the sector count number is checked to see if it is equal to “0”. If equal to “0” go to “End”, otherwise return to step 703.

In step 705, the current flash memory logical page is checked to see if what is to be read is larger than the last flash memory logical page that was written. If yes, go to the step 703, otherwise go to step 706.

In step 706, the data from the child block physical block and page is read and the sector count number is decremented.

In step 707, the sector count number is checked to see if it is equal to “0”. If yes, then go to “END”, otherwise go to step 705.

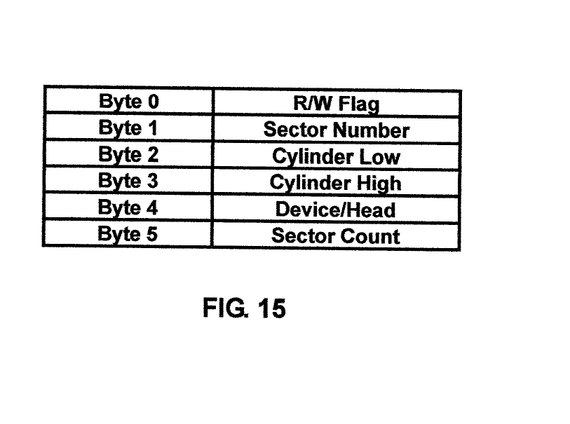

Refer to FIG. 15, which shows a command packet according to an embodiment of the present invention. When the microprocessor begins to execute the command, the device will download its parameters from the host, for example, read or write, the vendor command packet is as shown in FIG. 15.

The system will judge the address mode by the Device/Head byte. The flash memory device of the present invention supports both the LBA and CHS mode.

If the host provides the address using LBA mode, the device will convert it into CHS mode and then change the CHS mode into the physical address.

When the device executes a read command, the controller will first read data from the flash memory, sector by sector to a buffer (512 bytes) in the controller, then this sector will be sent to the host by a USB engine. The whole command will be completed when the number of sectors that have been sent to the host is equal to the sector count.

When the device executes a write command, the controller will read data from the host by the USB engine sector by sector to a buffer (512 bytes) in the controller, and then this sector will be stored in the flash memory. The whole command will be completed when the number of sectors that have been sent to the flash memory is equal to the sector count.

The device can support more than one piece of flash memory. In the present invention, multiple chip select pins are provided. When the device is initialized, it will check the type of the flash (the capacity) being used on board and how many chips the system has and the device will add up all the memory chips to find out the total capacity. When the host needs this kind of data, the device will provide the total capacity to the host, not just the capacity of one chip.

When the host sends a certain address (logic) to the device, the device will perform a calculation to find the exact chip and corresponding address that the host wants to access. Then the calculated address is used and the chip select pin is enabled.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A flash memory device comprising:
a universal serial bus (USB) connector for connecting the flash memory device to a host computer;
at least one flash memory module for storing data; and
a controller for controlling commands and data between the host computer and the flash memory device and for managing data in the at least one flash memory module.

2. The flash memory device of claim 1, further comprising an indicator for indicating status of the flash memory device.

3. The flash memory device of claim 1, further comprising a write protection switch for preventing writing to or erasing of the flash memory device.

4. The flash memory device of claim 1, further comprising a slave board with at least one flash memory module for extending memory size of the flash memory device.

5. The flash memory device of claim 1, further comprising a system buffer for buffering between the host computer and the flash memory device.

6. The flash memory device of claim 1, further comprising a state machine for creating read and write timing to the system buffer.

7. The flash memory device of claim 1, further comprising an error correction code (ECC) circuit for encoding an ECC when data is written to the flash memory device and for decoding the ECC when data is read from the flash memory device.

8. The flash memory device of claim 7, wherein the ECC circuit further comprises determining an address of invalid data when an error occurs and correcting the error.

9. The flash memory device of claim 1, further comprising a flash memory interface for controlling read and write commands to the at least one flash memory module.

10. The controller of the flash memory device of claim 1, wherein the controller is of a single chip design that does not need external random access memory (RAM) or read only memory (ROM).

11. The flash memory device of claim 1, further comprising a microprocessor for executing commands with parameters from the host.

12. A flash memory device comprising:
a universal serial bus (USB) connector for connecting the flash memory device to a host computer;
at least one flash memory module for storing data; and
a controller for controlling commands and data between the host computer and the flash memory device and for managing data in the at least one flash memory module, wherein the controller further comprises:
a microprocessor for executing commands with parameters from the host;
a system buffer for buffering between the host computer and the flash memory device; and
a state machine for creating read and write timing to the system buffer.

13. The flash memory device of claim 12, further comprising an indicator for indicating status of the flash memory device.

14. The flash memory device of claim 12, further comprising a write protection switch for preventing writing to or erasing of the flash memory device.

15. The flash memory device of claim 12, further comprising a slave board with at least one flash memory module for extending memory size of the flash memory device.

16. The flash memory device of claim 12, further comprising an error correction code (ECC) circuit for encoding an ECC when data is written to the flash memory device and for decoding the ECC when data is read from the flash memory device.

17. The flash memory device of claim 16, wherein the ECC circuit further comprises determining an address of invalid data when an error occurs and correcting the error.

18. The flash memory device of claim 12, filthier comprising a flash memory interface for controlling read and write commands to the at least one flash memory module.

19. The controller of the flash memory device of claim 12, wherein the controller is of a single chip design that does not need external random access memory (RAM) or read only memory (ROM).

20. A flash memory storage device comprising:
a universal serial bus (USB) connector for connecting the flash memory storage device to a host;
at least one flash memory module for storing data;
an indicator for indicating status of the flash memory storage device;
a write protection switch for providing write protection from the host;
a flash memory interface for controlling read and write commands to the flash memory module;
an extension connector for connecting to extended memory for the flash memory storage device;
a regulator for regulating voltage for the flash memory storage device;
a clock generator for generating a clock signal;
a USB interface for interfacing between the host and the flash memory interface; and
a controller for controlling commands and data between the host and the flash memory device and for managing data in the at least one flash memory module, wherein the controller further comprises:
a system buffer for buffering between the usb interface and the flash memory interface;
a microprocessor for reading commands and parameters from the system buffer and for executing commands with parameters; and
a state machine for creating read and write timing for the system buffer;

21. The flash memory storage device of claim 20, wherein the controller controls transfer of data to and from the host.

22. The flash memory storage device of claim 20, wherein the controller controls a USB interface.

23. The flash memory storage device of claim 20, wherein the controller receives commands from the host.

24. The flash memory storage device of claim 20, wherein the controller provides status to the host.

25. The flash memory storage device of claim 20, wherein the microprocessor reads commands and parameters from the system buffer.

26. The flash memory storage device of claim 20, wherein the microprocessor executes commands with parameters.

27. The flash memory storage device of claim 20, wherein the microprocessor manages and maps addresses to the system buffer while receiving or transferring data to and from the host

28. The flash memory storage device of claim 20, wherein the microprocessor manages commands such as erase, program, or read for the flash memory module.

29. The flash memory storage device of claim 20, wherein the microprocessor executes addressing methods according to an algorithm of the controller.

30. The flash memory storage device of claim 20, wherein the microprocessor manages system buffer addresses.

31. The flash memory storage device of claim 20, wherein the microprocessor further comprises:
a ROM for storing program code of the controller; and
a RAM for use by the controller when executing commands.

32. The flash memory storage device of claim 20, further comprising an extended memory board connected to the extension connector for extending memory for the flash memory storage device.
